(19) United States
(12) Patent Application Publication
(10) Pub. No.: US 2016/0048319 A1
(43) Pub. Date: Feb. 18, 2016

(54) Gesture-based Access to a Mix View

(71) Applicant: Microsoft Technology Licensing, LLC, Redmond, WA (US)

(72) Inventors: Nora I. Micheva, Seattle, WA (US); James David Peter Drage, Seattle, WA (US); Sean L. Flynn, North Bend, WA (US); John P. Aronson, Seattle, WA (US); Jeff G. Arnold, Sammamish, WA (US)

(73) Assignee: Microsoft Technology Licensing, LLC, Redmond, WA (US)

(21) Appl. No.: 14/462,280

(22) Filed: Aug. 18, 2014

(51) Int. Cl. G06F 3/0488; G06F 3/0484

(52) U.S. Cl. CPC G06F 3/04883; G06F 3/04842; G06F 3/04847

(57) ABSTRACT

Techniques for gesture-based access to a mixed view associated with an application representation are described. In one or more implementations, a user interface is exposed by an operating system of a computing device. The user interface includes a concurrent display of a plurality of representations of applications that are selectable by a user to launch respective applications. Gesture-based techniques can be used to interact with an application representation to cause one or more visible targets to appear adjacent the representation. The individual targets are individually associated with some type of application functionality, e.g., a quick action or a deep link into content associated with the application. An individual target can then be selected, e.g., touch-selected, by a user to initiate the associated functionality.

### BACKGROUND

Computing devices may employ a variety of applications to access an ever increasing variety of functionality. As a computing device may include tens and even hundreds of applications, techniques have been developed to manage user interaction with the applications, such as to select applications for execution by the computing device.

Some conventional techniques that were utilized to manage this interaction utilized objects, such as icons, to represent the application. Therefore, a user wanting to interact with the application in some manner would select the icon to launch the application, such as from a root level of a file management system of the computing device. The selection then resulted in a modal transfer away from a user interface that included the icons (e.g., the root level) to a user interface of the application itself such that a user may view content related to the application. If the user wished to interact with application features that were several levels down in the application's hierarchy, the user would have to physically navigate through the various application layers to reach the desired functionality.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Techniques for gesture-based access to a mixed view associated with an application representation are described. In one or more implementations, a user interface is exposed by an operating system of a computing device. The user interface includes a concurrent display of a plurality of representations of applications that are selectable by a user to launch respective applications. Gesture-based techniques can be used to interact with an application representation to cause one or more visible targets to appear adjacent the representation. The individual targets are individually associated with some type of application functionality, e.g., a quick action or a deep link into content associated with the application. An individual target can then be selected, e.g., touch-selected, by a user to initiate the associated functionality.

In one or more implementations, a computing device includes one or more modules implemented at least partially in hardware. The one or more modules are configured to output a user interface for display. The user interface includes a concurrent display of a plurality of representations of applications that are selectable by a user to launch respective applications. Gesture-based techniques can be used to interact with an application representation to cause one or more visible targets to appear adjacent the representation. The individual targets are individually associated with some type of application functionality, e.g., a quick action or a deep link into content associated with the application. An individual target can then be selected, e.g., touch-selected, by a user to initiate the associated functionality.

In one or more implementations, a computing device includes a processing system and memory having instructions that are executable by the processing system to include an application having a plurality of entry points that are different, one from another, to access different parts of the application and an operating system that is configured to output a representation of the application that is selectable to launch the application. Gesture-based techniques can be used to interact with an application representation to cause one or more visible targets to appear adjacent the representation. Each target is associated with an individual entry point. An individual target can then be selected, e.g., touch-selected, by a user to obtain direct access to an associated entry point.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 depicts an environment in an example implementation that is configured to perform the embodiments described herein.

FIG. 2 depicts an example implementation showing a representation of an application of FIG. 1 as having a plurality of user-selectable targets.

FIG. 3 depicts an example gestural input to access a mix view in accordance with one embodiment.

FIG. 4 depicts an example application representation having a plurality of user-selectable targets associated with the application representation.

FIG. 5 depicts an example implementation showing examples of configurations of the representation of FIG. 4 that includes a plurality of user-selectable targets.

FIG. 6 is a flow diagram that describes steps in a method in accordance with one or more embodiments.

FIG. 7 is a flow diagram that describes steps in a method in accordance with one or more embodiments.

FIG. 8 illustrates various components of an example device that can be implemented as any type of computing device as described with reference to FIGS. 1-7 to implement embodiments of the techniques described herein.

### DETAILED DESCRIPTION

Overview

Conventional techniques utilized to interact with an application typically involved selection of a representation of the application to launch the application to then gain access to functionality of the application. This can typically involve several user actions, once the application is launched, to access the desired functionality.

Techniques for gesture-based access to a mixed view associated with an application representation are described. In one or more implementations, a user interface is exposed by an operating system of a computing device. The user interface includes a concurrent display of a plurality of representations of applications that are selectable by a user to launch respective applications. Gesture-based techniques can be used to interact with an application representation to cause one or more visible targets to appear adjacent the representation. The individual targets are individually associated with some type of application functionality, e.g., a quick action or a deep link into content associated with the application. An individual target can then be selected, e.g., touch-selected, by a user to initiate the associated functionality. The application representation can include any suitable object including, by way of example and not limitation, an icon, a tile, and so on.

For example, the representation may be configured as a tile that includes a plurality of targets (e.g., sub-tiles) that are user-selectable. The user-selectable targets are configured such that selection by a user causes access to corresponding functionality of the application and in this way may provide a “deep link” to various functionality of the application. The tile, for instance, may include a user-selectable target to navigate to a root level (e.g., welcome screen) of the application, e.g., a start screen of a weather application. Other user-selectable targets may be utilized to access other application functionality, such as weather at different geographic locations. In this way, a user may directly access different parts of an application directly from the representation of the application that launches the application. A variety of other examples are also contemplated, further discussion of which may be found in relation to the following sections.

In the following discussion, an example environment is first described that may employ the techniques described herein. Example procedures are then described which may be performed in the example environment as well as other environments. Consequently, performance of the example procedures is not limited to the example environment and the example environment is not limited to performance of the example procedures.

Example Environment

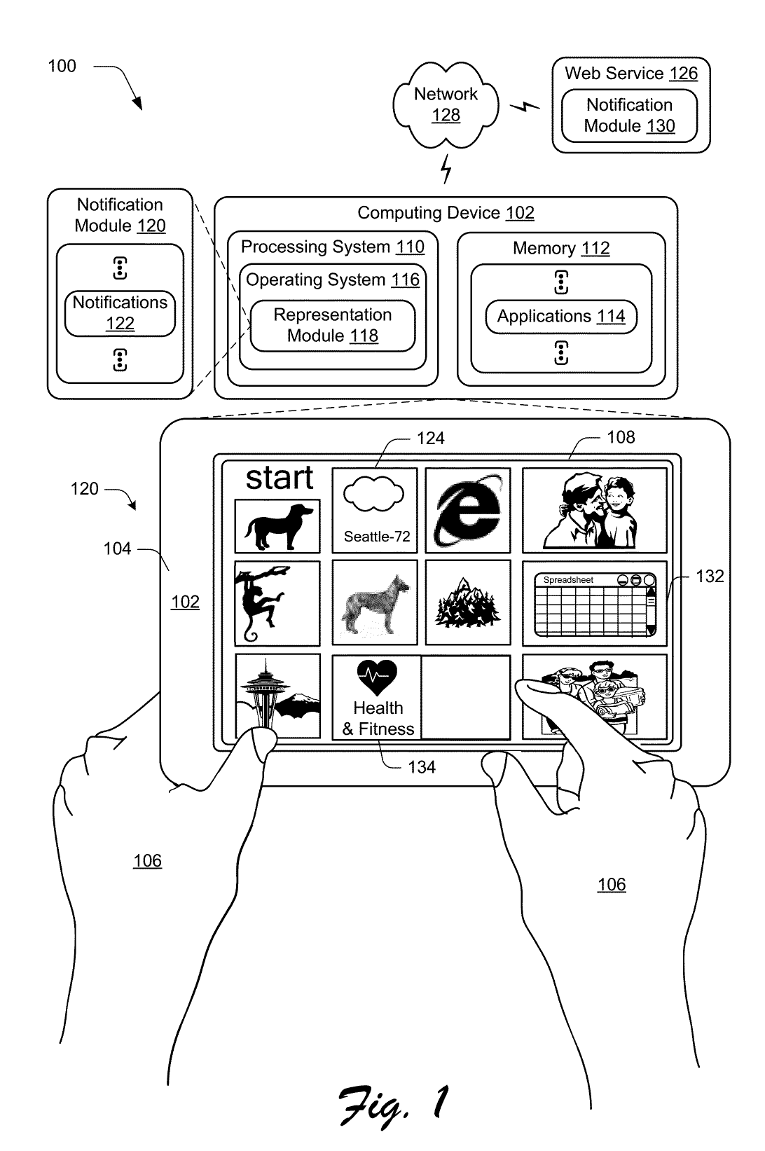

FIG. 1 is an illustration of an environment 100 in an example implementation that is operable to employ the techniques described herein. The illustrated environment 100 includes an example of a computing device 102, which is illustrated as a mobile computing device (e.g., a tablet or mobile phone) having a housing 104 that is configured to be held by one or more hands 106 of a user. A variety of other configurations of the computing device 102 are also contemplated.

For example, the computing device 102 may be configured as a traditional computer (e.g., a desktop personal computer, laptop computer, and so on), a mobile station, an entertainment appliance, a wireless phone, a tablet, a netbook, and so forth as further described in relation to FIG. 8. Thus, the computing device 102 may range from full resource devices with substantial memory and processor resources (e.g., personal computers, game consoles) to a low-resource device with limited memory and/or processing resources (e.g., traditional set-top boxes, hand-held game consoles). The computing device 102 may also relate to software that causes the computing device 102 to perform one or more operations.

The computing device 102 is also illustrated as including a display device 108, a processing system 110, and an example of computer-readable storage media, which in this instance is memory 112. The memory 112 is configured to maintain applications 114 that are executable by the processing system 110 to perform one or more operations.

The processing system 110 is not limited by the materials from which it is formed or the processing mechanisms employed therein. For example, the processing system 110 may be comprised of semiconductor(s) and/or transistors (e.g., electronic integrated circuits (ICs)), such as a system on a chip, processors, central processing units, processing cores, functional blocks, and so on. In such a context, executable instructions may be electronically-executable instructions. Alternatively, the mechanisms of or for processing system 110, and thus of or for a computing device, may include, but are not limited to, quantum computing, optical computing, mechanical computing (e.g., using nanotechnology), and so forth. Additionally, although a single memory 112 is shown, a wide variety of types and combinations of memory may be employed, such as random access memory (RAM), hard disk memory, removable medium memory, and other types of computer-readable media.

The computing device 102 is further illustrated as including an operating system 116. The operating system 116 is configured to abstract underlying functionality of the computing device 102 to applications 114 that are executable on the computing device 102. For example, the operating system 116 may abstract the processing system 110, memory 112, network, input/output, and/or display functionality of the display device 108, and so on such that the applications 114 may be written without knowing “how” this underlying functionality is implemented. The application 114, for instance, may provide data to the operating system 116 to be rendered and displayed by the display device 104 without understanding how this rendering will be performed. The operating system 116 may also represent a variety of other functionality, such as to manage a file system and user interface that is navigable by a user of the computing device 102, such as to manage access to applications 114 in a graphical user interface as further described below.

The operating system 116 may also represent a variety of other functionality, such as to manage a file system and a user interface that is navigable by a user of the computing device 102. An example of this is illustrated as a representation module 118 that is representative of functionality to generate and manage representations of applications 114.

The representation module 118, for instance, may generate a variety of representations for the plurality of the applications 114. The representations may be configured in a variety of ways, such as icon, tiles, textual descriptions, and so on. The representations may also be utilized in a variety of ways, such as at a root level of a hierarchical file structure, e.g., each of the other levels are “beneath” the root level in the hierarchy. An example of this is illustrated as an application launcher (e.g., start screen) that is displayed in a user interface on the display device 108 in FIG. 1. The representations shown in the illustrated example are selectable to launch a corresponding one of applications 114 for execution by the processing system 110 of the computing device 102. In this way, a user may readily navigate through a file structure and initiate execution of applications 114 of interest. The inventive techniques described in this document can, however, be implemented in connection with application launchers other than a start screen, e.g., a home screen, a launch screen, and the like.

Thus, the representation module 118 is representative of functionality to manage representations of applications 114 (e.g., tiles, icons, and so on) and content consumable by the applications 114. In some instances, the representations may include notifications that may be displayed as part of the representations without launching the represented applications 114, e.g., as text or graphics within the display of the representation. This functionality is illustrated as a notification module 120 that is configured to manage notifications 122 for inclusion as part of the representations.

For example, a representation 124 of a weather application is illustrated as including a notification that indicates a name and current weather conditions, e.g., “72° ” and an illustration of a cloud. In this way, a user may readily view information relating to applications 114 without having to launch and navigate through each of the applications 114. In one or more implementations, the notifications 122 may be managed without executing the corresponding applications 114. For example, the notification module 120 may receive the notifications 122 from a variety of different sources, such as from software (e.g., other applications executed by the computing device 102), from a web service 126 via a network 128, and so on.

This may be performed responsive to registration of the applications 114 with the notification module 120 to specify from where and how notifications are to be received. The notification module 120 may then manage how the notifications 122 are displayed as part of the representations without executing the applications 114. This may be used to improve battery life and performance of the computing device 102 by not executing each of the applications 114 to output respective notifications 122.

Although this discussion describes incorporation of the notification module 120 at the client, functionality of the notification module 120 may be implemented in a variety of ways. For example, functionality of a notification module 120 may be incorporated by the web service 126 in whole or in part. The notification module 130 of the web service 126, for instance, may process notifications received from other web services and manage the notifications for distribution to the computing device 102 over the network 128, e.g., through registration of the applications 114 with the notification module 120, 130 such that the notifications 122 may be output as part of the representations without execution the represented applications 114.

Representations that are generated by the representation module 118 of the operating system 116 on behalf of the applications 114 may be configured in a variety of ways. As illustrated, for instance, the representations 124, 132, 134 may be configured according to a variety of different sizes. The representation 124 may be configured for output of notifications 122 as previously described, a representation 132 may be configured to access specific content (e.g., a particular spreadsheet in this example), and so on.

Additionally, the representations can be configured to enable gesture-based access to a mixed view associated with an application representation. The mixed view includes a plurality of user-selectable targets that can be selected by the user to access functionality associated with the application, as will be described below in more detail.

In one or more implementations, a user interface is exposed by an operating system of a computing device. The user interface includes a concurrent display of a plurality of representations of applications that are selectable by a user to launch respective applications, such as the user interface shown in FIG. 1. Gesture-based techniques can be used to interact with an application representation to cause one or more visible targets to appear adjacent the representation. The individual targets are individually associated with some type of application functionality, e.g., a quick action or a deep link into content associated with the application. An individual target can then be selected, e.g., touch-selected, by a user to initiate the associated functionality.

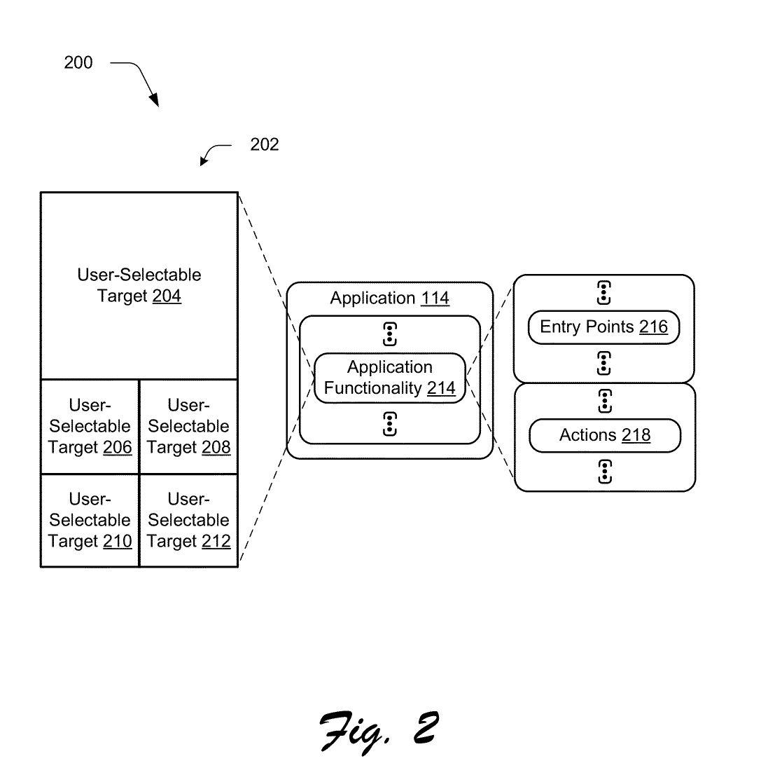

FIG. 2 depicts an example implementation 200 showing a representation of an application 114 of FIG. 1 as having a plurality of user-selectable targets. In this example, a representation 202 is illustrated that corresponds to a single application 114, i.e., that represents that application 114 in a file management structure of the computing device 102 of FIG. 1. Here, the application representation is also user-selectable so, in that sense, the application representation also constitutes a user-selectable target. The representation includes a plurality of user-selectable targets 204, 206, 208, 210, 212, each of which corresponds to a different application functionality 214. In this way, a user may select a desired one of the user-selectable targets 204-212 to gain direct access to a respective functionality.

The application functionality 214 may be configured in a variety of ways. For example, the application functionality 214 may correspond to a plurality of entry points 216 of the application 114. The application 114, for instance, may include a root level entry point such as a welcome screen as well as different pages, tabs, chapters, and other sections that may also be utilized as entry points 216. In this way, the user-selectable targets 204-212 may provide direct access to different parts of the application through use of the entry points 216 in a modal manner that causes output of a relevant user interface.

In another example, the application functionality 214 may be configured as actions 218 (e.g., quick actions) that are associated with the application. These actions are directly accessible via the user-selectable targets 204-212 and thus, can be quickly performed. A user, for instance, may select one of the user-selectable targets 204-212 to gain access to actions 218 that may be performed by the application 114 in a non-modal manner. For example, a user may select a user-selectable target of the representation 202 to initiate execution of an action 218 by the application 114 without navigating away from a display of the representation 202, an example of which is provided below. Thus, application developers may configure actions 218 that may be directly accessed via the application 202 in a non-modal manner.

Consider now how user-selectable targets can be exposed through gesture-based techniques.

Exposing User-Selectable Targets

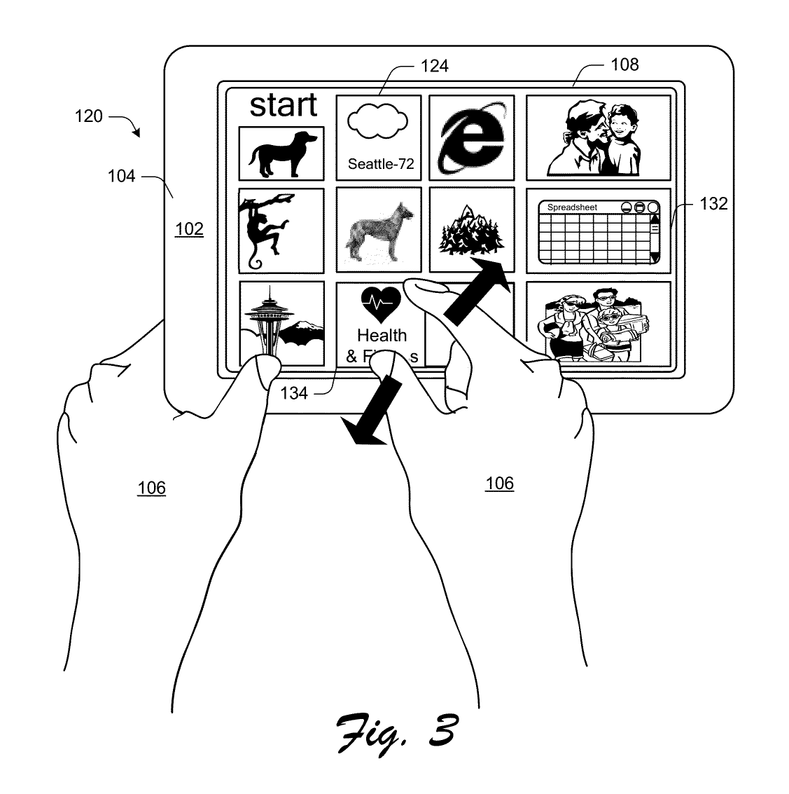

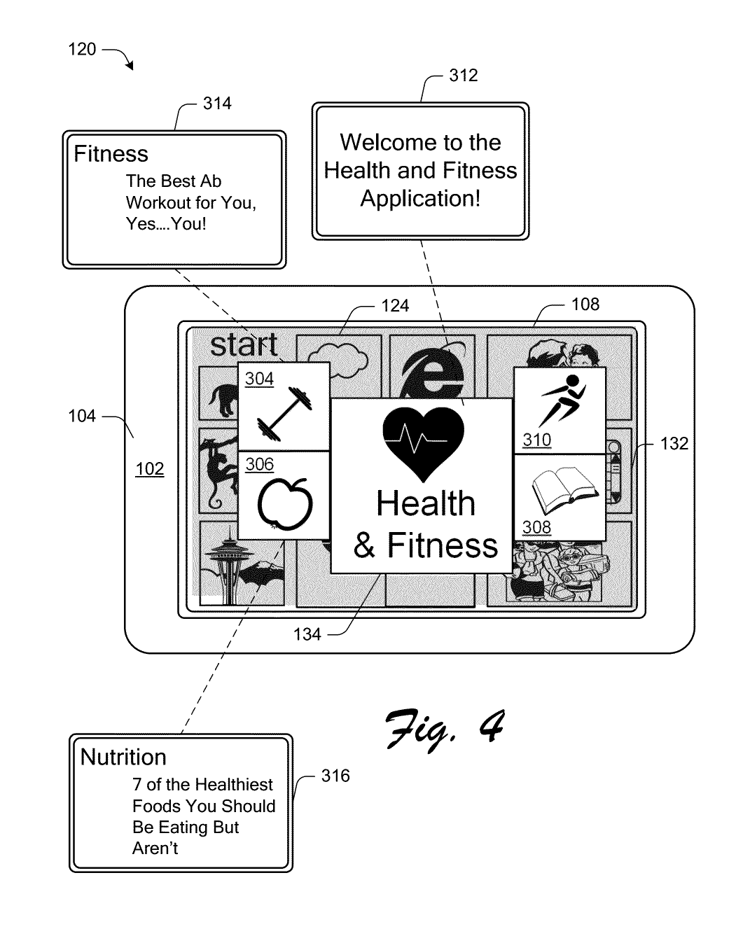

FIG. 3 illustrates computing device 102 in accordance with one or more embodiments. In this example, a user, using their right hand, provides gestural input relative to application representation 134. Any suitable type of gestural input can be utilized. For example, gestural input can comprise any type of touch-based input such as rapid tap combinations, touch and slide, and the like. In this particular example, a two-finger pinch-type gesture is used to cause multiple user-selectable targets to be exposed. As an example, consider FIG. 4.

There, application representation 134 has been enlarged and relocated to the center of the display. In addition multiple user-selectable targets have “flown” out and are located adjacent the application representation 134.

In this example, the representation 134 corresponds to a single application, which is a health and fitness application, although other applications are also contemplated without departing form the spirit and scope thereof.

The representation 134 (which itself constitutes a user-selectable target) includes a plurality of user-selectable targets 304, 306, 308, and 310. As previously described, each of the user-selectable targets 302-310 is selectable by a user to directly access corresponding application functionality of the represented application.

For example, representation 134 and user-selectable targets 304 and 306 are user selectable to access different ones of a plurality of entry points 216 (FIG. 2) of the application 114. Application representation 134, for instance, is selectable to access an entry point 312 of the application at a root level of the application, e.g., a welcome screen or other user interface level that is arranged at a root level of a hierarchy of a user interface of the application. Thus, selection of this application representation 134 provides directs access to a root level of the application with which it is associated by launching the application and causing navigation to that access point automatically and without further user intervention.

User-selectable targets 304 and 306 provide direct access to different entry points 314, 316 of the application other than the root level access point 312 corresponding to application representation 134. User-selectable target 304, for instance, is selectable to provide direct access to an entry point 314 of the application 114 relating to fitness. Likewise, user-selectable target 306 is selectable to provide direct access to an entry point 316 of the application 114 relating to nutrition.

Thus, the application representation 134 and user-selectable targets 304, 306 may be selected to launch execution of the application (if not already executed) and navigate to corresponding application functionality. The corresponding application functionality, in this example, constitute entry points 312, 314 and 316. Navigation can be performed in a modal manner that causes navigation away from display of the representation 134 to output of a user interface at those entry points 312, 314, 316, e.g., through use of a window, a full-screen immersive view, and so on. Non-modal direct access techniques are also contemplated, further discussion of which may be found in the following and shown in a corresponding figure.

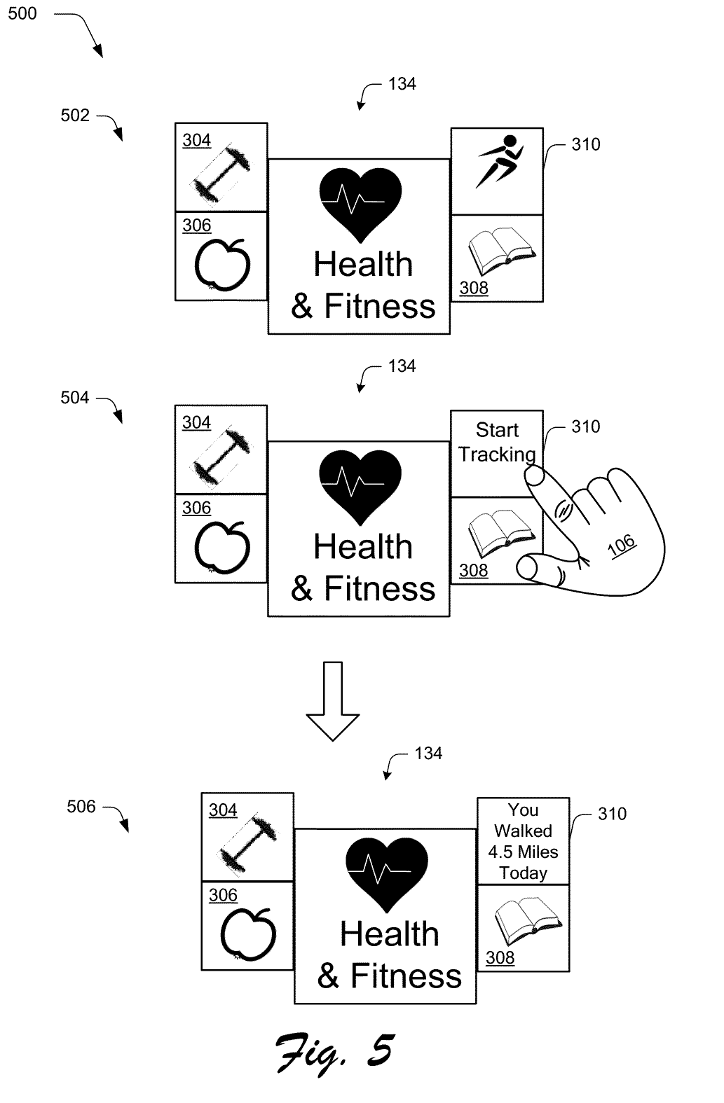

FIG. 5 depicts an example implementation 500 showing direct access of user-selectable targets of the representation 134. This example is illustrated using first, second, and third stages 502, 504, 506. At the first stage 502, representation 134 is displayed in a user interface that includes user-selectable targets previously described.

At the second stage 504, a finger of a user's hand 106 is illustrated as selecting a user-selectable target 310. In response, an action 218 (FIG. 2) is initiated that corresponds to the user-selectable target 310, such as initiating tracking of an amount a user runs by the health and fitness application. As illustrated, this initiation of application functionality is performed in this instance through non-modal interaction with the user-selectable target 310. Thus, a user may initiate execution of the representation application and corresponding action through direct access provided by the user-selectable target 310 without navigating away from the representation 134.

At the third stage 506, the representation 134 outputs notifications generated as part of the user-selectable portion 310, which in this instance is the distance a user has run.

Example Procedures

The following discussion describes gesture-based techniques that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference will be made to the example environment described above.

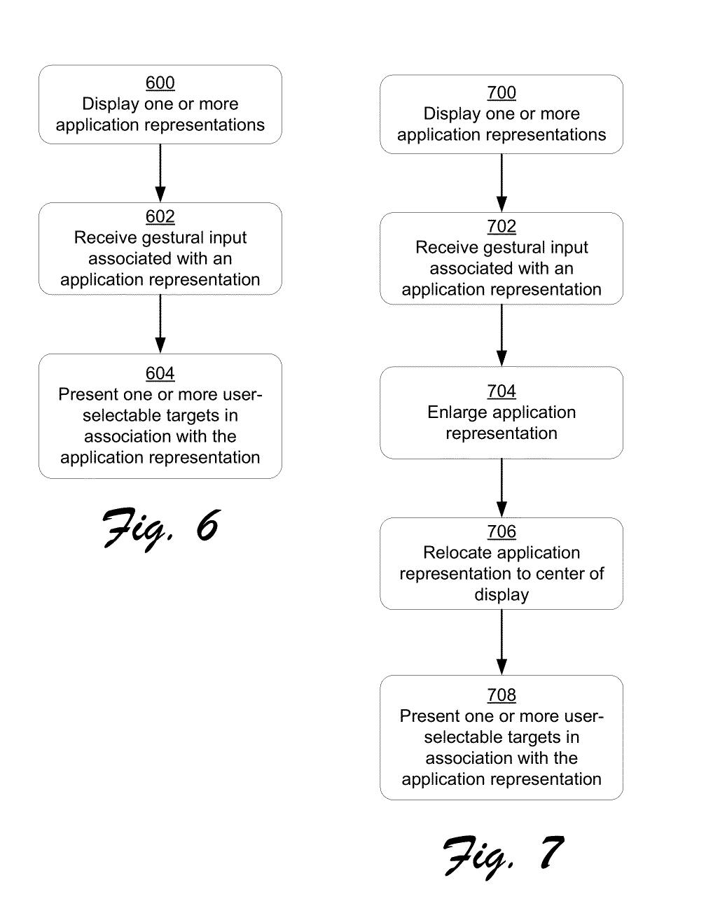

In FIG. 6, step 600 displays one or more application representations. Any suitable type of application representation can be utilized, examples of which are provided above. The application representations can be utilized to launch their associated applications as well as to visually access user-selectable targets.

Step 602 receives gestural input associated with an application representation. Any suitable type of gestural input can be received including, by way of example and not limitation, touch gestures such as multiple taps, touch and slide, two-finger pinch, and the like. Responsive to receiving the gestural input, step 604 presents one or more user-selectable targets in association with the application representation. The user-selectable targets for a respective application are user-selectable by a user to obtain direct access to a respective functionality associated with the application, for example, a quick action or a deep link.

Responsive to an input indicative of user selection of one of the user-selectable targets, direct access is provided to the respective application functionality.

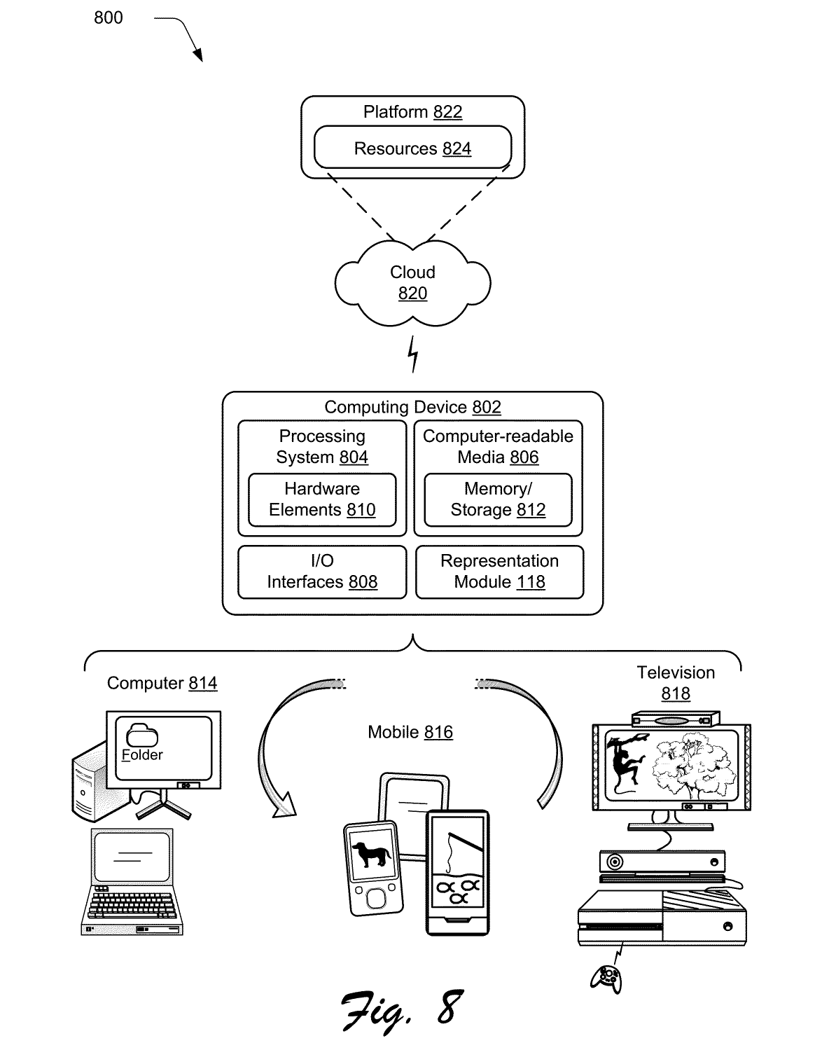

FIG. 7 illustrates another procedure in accordance with one or more embodiments.

Step 700 displays one or more application representations. Examples of how this can be done are provided above. Step 702 receives gestural input associated with an application representation. Any suitable type of gestural input can be received, examples of which are provided above. Responsive to receiving the gestural input, step 704 enlarges the application representation and step 706 relocates application representation to a center of an associated display. Step 708 presents one or more selectable targets in association with the application representation. This step can be performed in any suitable way. In at least some embodiments, presentation of the selectable targets can occur through an animation in which the selectable targets “fly out” from behind the enlarged application representation to assume their respective positions adjacent the enlarged application representation.

Having considered example methods in accordance with one or more embodiments, consider now a discussion of an example device that can be utilized to implement the embodiments described herein.

Example System and Device

FIG. 8 illustrates an example system generally at 800 that includes an example computing device 802 that is representative of one or more computing systems and/or devices that may implement the various techniques described herein, which is illustrated through inclusion of the representation module 118. The computing device 802 may be, for example, a server of a service provider, a device associated with a client (e.g., a client device), an on-chip system, and/or any other suitable computing device or computing system.

The example computing device 802 as illustrated includes a processing system 804, one or more computer-readable media 806, and one or more I/O interface 808 that are communicatively coupled, one to another. Although not shown, the computing device 802 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 804 is representative of functionality to perform one or more operations using hardware. Accordingly, the processing system 804 is illustrated as including hardware element 810 that may be configured as processors, functional blocks, and so forth. This may include implementation in hardware as an application specific integrated circuit or other logic device formed using one or more semiconductors. The hardware elements 810 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 806 is illustrated as including memory/storage 812. The memory/storage 812 represents memory/storage capacity associated with one or more computer-readable media. The memory/storage component 812 may include volatile media (such as random access memory (RAM)) and/or nonvolatile media (such as read only memory (ROM), Flash memory, optical disks, magnetic disks, and so forth). The memory/storage component 712 may include fixed media (e.g., RAM, ROM, a fixed hard drive, and so on) as well as removable media (e.g., Flash memory, a removable hard drive, an optical disc, and so forth). The computer-readable media 806 may be configured in a variety of other ways as further described below.

Input/output interface(s) 808 are representative of functionality to allow a user to enter commands and information to computing device 802, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 802 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 802. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 802, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 810 and computer-readable media 806 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 810. The computing device 802 may be configured to implement particular instructions and/or functions corresponding to the software and/or hardware modules. Accordingly, implementation of a module that is executable by the computing device 802 as software may be achieved at least partially in hardware, e.g., through use of computer-readable storage media and/or hardware elements 810 of the processing system 804. The instructions and/or functions may be executable/operable by one or more articles of manufacture (for example, one or more computing devices 802 and/or processing systems 804) to implement techniques, modules, and examples described herein.

As further illustrated in FIG. 8, the example system 800 and enables ubiquitous environments for a seamless user experience when running applications on a personal computer (PC), a television device, and/or a mobile device. Services and applications run substantially similar in all three environments for a common user experience when transitioning from one device to the next while utilizing an application, playing a video game, watching a video, and so on.

In the example system 800, multiple devices are interconnected through a central computing device. The central computing device may be local to the multiple devices or may be located remotely from the multiple devices. In one embodiment, the central computing device may be a cloud of one or more server computers that are connected to the multiple devices through a network, the Internet, or other data communication link.

In one embodiment, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one embodiment, a class of target devices is created and experiences are tailored to the generic class of devices. A class of devices may be defined by physical features, types of usage, or other common characteristics of the devices.

In various implementations, the computing device 802 may assume a variety of different configurations, such as for computer 814, mobile 816, and television 818 uses. Each of these configurations includes devices that may have generally different constructs and capabilities, and thus the computing device 802 may be configured according to one or more of the different device classes. For instance, the computing device 802 may be implemented as the computer 814 class of a device that includes a personal computer, desktop computer, a multi-screen computer, laptop computer, netbook, and so on.

The computing device 802 may also be implemented as the mobile 816 class of device that includes mobile devices, such as a mobile phone, portable music player, portable gaming device, a tablet computer, a multi-screen computer, and so on. The computing device 802 may also be implemented as the television 818 class of device that includes devices having or connected to generally larger screens in casual viewing environments. These devices include televisions, set-top boxes, gaming consoles, and so on.

The techniques described herein may be supported by these various configurations of the computing device 802 and are not limited to the specific examples of the techniques described herein. This functionality may also be implemented all or in part through use of a distributed system, such as over a “cloud” 820 via a platform 822 as described below.

The cloud 820 includes and/or is representative of a platform 822 for resources 824. The platform 822 abstracts underlying functionality of hardware (e.g., servers) and software resources of the cloud 820. The resources 824 may include applications and/or data that can be utilized while computer processing is executed on servers that are remote from the computing device 802. Resources 824 can also include services provided over the Internet and/or through a subscriber network, such as a cellular or Wi-Fi network.

The platform 822 may abstract resources and functions to connect the computing device 802 with other computing devices. The platform 822 may also serve to abstract scaling of resources to provide a corresponding level of scale to encountered demand for the resources 824 that are implemented via the platform 822. Accordingly, in an interconnected device embodiment, implementation of functionality described herein may be distributed throughout the system 800. For example, the functionality may be implemented in part on the computing device 802 as well as via the platform 822 that abstracts the functionality of the cloud 820.

Conclusion

Techniques for gesture-based access to a mixed view associated with an application representation are described. In one or more implementations, a user interface is exposed by an operating system of a computing device. The user interface includes a concurrent display of a plurality of representations of applications that are selectable by a user to launch respective applications. Gesture-based techniques can be used to interact with an application representation to cause one or more visible targets to appear adjacent the representation. The individual targets are individually associated with some type of application functionality, e.g., a quick action or a deep link into content associated with the application. An individual target can then be selected, e.g., touch-selected, by a user to initiate the associated functionality.

Although the embodiments have been described in language specific to structural features and/or methodological acts, it is to be understood that the invention defined in the appended claims is not necessarily limited to the specific features or acts described. Rather, the specific features and acts are disclosed as example forms of implementing the claimed subject matter.

What is claimed is:

1. A method comprising:
displaying, on a computing device, one or more application representations that are capable of launching an associated application;
receiving gestural input associated with one of the application representations;
responsive to receiving the gestural input, presenting one or more user-selectable targets in association with the application representation, the user-selectable targets being configured to enable direct access to a respective associated application functionality.

2. The method of claim 1, wherein the gestural input comprises a touch input.

3. The method of claim 1, wherein the gestural input comprises a two-finger pinch gesture.

4. The method of claim 1, wherein application functionality comprises a deep link.

5. The method of claim 1, wherein application functionality comprises an action.

6. The method of claim 1, wherein the one or more application representations comprise tiles.

7. The method of claim 1, wherein the one or more application representations comprise objects other than tiles.

8. One or more computer readable storage media storing computer readable instructions which, when executed, implement a method comprising:
displaying, on a computing device, one or more application representations that are capable of launching an associated application;
receiving touch gesture input associated with one of the application representations;
responsive to receiving the touch gesture input, presenting one or more user-selectable targets in association with the application representation, the user-selectable targets being configured to enable direct access to a respective associated application functionality.

9. The one or more computer readable storage media of claim 8, wherein the touch gesture input comprises a two-finger pinch gesture.

10. The one or more computer readable storage media of claim 8, wherein the touch gesture input comprises a touch gesture input other than a two-finger pinch gesture.

11. The one or more computer readable storage media of claim 8, wherein the application functionality comprises a deep link to content.

12. The one or more computer readable storage media of claim 8, wherein the application functionality comprises an action.

13. The one or more computer readable storage media of claim 8, wherein the one or more application representations comprise tiles.

14. The one or more computer readable storage media of claim 8, wherein the one or more application representations comprise objects other than tiles.

15. A computing device comprising:
a display;
one or more processors;
one or more computer readable storage media having computer readable instructions stored thereon which, when executed, perform operations comprising:
displaying, on the display, one or more application representations that are capable of launching an associated application;
receiving gestural input associated with an application representation;
responsive to receiving the gestural input, enlarging the application representation and relocating the application representation on the display; and
presenting one or more user-selectable targets in association with the application representation, the user selectable targets being configured to enable direct access to a respective associated application functionality.

16. The computing device of claim 15, wherein said relocating comprises relocating the application representation to a center of the display.

17. The computing device of claim 15, wherein said presenting comprises using an animation in which the user-selectable targets fly out from behind the application representation.

18. The computing device of claim 15, wherein the gestural input comprises a two-finger pinch gesture.

19. The computing device of claim 15, wherein the application functionality comprises a deep link or action.

20. The computing device of claim 15, wherein the one or more application representations comprise tiles.
